(19) United States
(12) Patent Application Publication
(10) Pub. No.: US 2026/0328347 A1
(43) Pub. Date: Oct. 22, 2026

(54) METHODS AND INTERNET OF THINGS SYSTEMS FOR HEAT COMPENSATION IN SMART GAS PIPELINE NETWORKS BASED ON CALORIFIC VALUE MONITORING

(71) Applicant: CHENGDU QINCHUAN IOT TECHNOLOGY CO., LTD., Chengdu (CN)

(72) Inventors: Zehua SHAO, Chengdu (CN); Yong LI, Chengdu (CN); Lei HE, Chengdu (CN); Yongzeng LIANG, Chengdu (CN)

(73) Assignee: CHENGDU QINCHUAN IOT TECHNOLOGY CO., LTD., Chengdu (CN)

(21) Appl. No.: 19/710,315

(22) Filed: Jun. 16, 2026

(30) Foreign Application Priority Data
Feb. 6, 2026 (CN) 202610178775.0

(51) Int. Cl. G16Y 10/35; F17D 5/00; G06Q 50/06; G16Y 40/10

(52) U.S. Cl. CPC F17D 5/005; G06Q 50/06; G16Y 10/35; G16Y 40/10

(57) ABSTRACT

The present disclosure relates to methods and Internet of Things (IoT) systems for heat compensation. The method includes determining a gas calorific value of a target node based on the gas monitoring data, the gas usage data, the gas combustion characteristic, the combustion exhaust gas characteristic, and the gas composition data; determining a target gas calorific value of each terminal node, and determining a heat offset value of the terminal node based on the target gas calorific value and the terminal gas calorific value; determining a valve to be regulated based on heat offset values of the plurality of terminal nodes; determining a calorific value adjustment parameter of a gas supply pipeline corresponding to each valve to be regulated based on the heat offset values; and determining a calorific value control parameter of the valve to be regulated based on the calorific value adjustment parameter.

### CROSS-REFERENCE TO RELATED APPLICATIONS

This application claims the priority of Chinese Patent Application No. 202610178775.0, filed on Feb. 6, 2026, the contents of which are hereby incorporated by reference.

### TECHNICAL FIELD

The present disclosure generally relates to the field of heat compensation for gas pipeline networks, and in particular to methods and Internet of Things systems for heat compensation in smart gas pipeline networks based on calorific value monitoring.

### BACKGROUND

A gas pipeline system is an important component of urban infrastructure. During the gas transmission process, fluctuations in gas calorific value, such as composition changes caused by mixing of a plurality of gas sources and changes in temperature and pressure, directly affect the usage effect of terminal users.

Currently, the monitoring and regulation of gas calorific value mainly rely on manual measurement and manual adjustment, which is inefficient and susceptible to environmental factors. This results in inconsistent calorific value of gas at the end user side, poor user experience, and prominent problems of energy waste. In addition, the uncertainty of deposits in pipelines in the pipeline network and the uncertainty of lag time in valve regulation further increase the difficulty of calorific value regulation, making precise control extremely complicated.

To address the above problems, it is necessary to provide methods and Internet of Things systems for heat compensation in smart gas pipeline networks based on calorific value monitoring, so as to realize real-time monitoring of gas calorific value and automatic calculation of calorific value deviation. Furthermore, an optimal valve regulation strategy can be determined through intelligent algorithms based on the pipeline network structure and deposit conditions, thereby achieving uniform regulation of calorific value.

### SUMMARY

One or more embodiments of the present disclosure provide a method for heat compensation in smart gas pipeline networks based on calorific value monitoring. The method is implemented by a gas company management platform of an Internet of Things (IoT) system for heat compensation in smart gas pipeline networks based on calorific value monitoring. The method includes: obtaining the gas monitoring data, the gas usage data, the gas combustion characteristic, the combustion exhaust gas characteristic, and the gas composition data from the smart gas equipment object platform via the gas company sensing network platform; determining a gas calorific value of a target node based on the gas monitoring data, the gas usage data, the gas combustion characteristic, the combustion exhaust gas characteristic, and the gas composition data, wherein the gas calorific value of the target node includes a terminal gas calorific value of the terminal node, and the terminal gas calorific value is determined based on the gas usage data, the gas combustion characteristic, and the combustion exhaust gas characteristic; for each of a plurality of terminal nodes, determining a target gas calorific value of the each of the plurality of terminal nodes, and determining a heat offset value of the each of the plurality of terminal nodes based on the target gas calorific value and the terminal gas calorific value; determining a valve to be regulated based on heat offset values of the plurality of terminal nodes; for each of a plurality of valves to be regulated, determining a calorific value adjustment parameter of a gas supply pipeline corresponding to the each of the plurality of valves to be regulated based on the heat offset values of the plurality of terminal nodes; determining a calorific value control parameter of the each of the plurality of valves to be regulated based on the calorific value adjustment parameter; and in response to obtaining an execution confirmation instruction, regulating a valve opening degree of a valve control device according to calorific value control parameters of the plurality of valves to be regulated.

One or more embodiments of the present disclosure provide an Internet of Things (IoT) system for heat compensation in smart gas pipeline networks based on calorific value monitoring. The IoT system includes a gas company sensing network platform, a smart gas equipment object platform, and the gas company management platform. The smart gas equipment object platform includes at least one of a gas sensing device, a combustion monitoring device, or a composition detection device. The gas sensing device is disposed at a pipeline network node in a gas pipeline network to monitor gas monitoring data of the pipeline network node. The combustion monitoring device is disposed at a terminal node to monitor gas usage data, a gas combustion characteristic, and a combustion exhaust gas characteristic of the terminal node. The composition detection device is disposed at a detection gate station to detect gas composition data of the detection gate station. The gas company management platform is configured to execute the method for heat compensation in smart gas pipeline networks based on calorific value monitoring.

One or more embodiments of the present disclosure provide a non-transitory computer-readable storage medium. The storage medium stores computer instructions. When a computer reads the computer instructions in the storage medium, the computer executes the method for heat compensation in smart gas pipeline networks based on calorific value monitoring.

### BRIEF DESCRIPTION OF THE DRAWINGS

The present disclosure will be further described by way of exemplary embodiments. These exemplary embodiments will be described in detail through the accompanying drawings. These embodiments are not limiting. In these embodiments, the same counts denote the same structures, wherein:

FIG. 1 is a schematic diagram of a platform structure of an Internet of Things (IoT) system for heat compensation in smart gas pipeline networks based on calorific value monitoring according to some embodiments of the present disclosure;

FIG. 2 is an exemplary flowchart of a method for heat compensation in smart gas pipeline networks based on calorific value monitoring according to some embodiments of the present disclosure;

FIG. 3 is an exemplary flowchart of a calorific value estimation model according to some embodiments of the present disclosure; and

FIG. 4 is an exemplary flowchart for regulating a valve opening degree according to some embodiments of the present disclosure.

### DETAILED DESCRIPTION

To illustrate the technical solutions of the embodiments of the present disclosure more clearly, the drawings used in the description of the embodiments are briefly introduced below. Obviously, the drawings in the following description are merely some examples or embodiments of the present disclosure. For those of ordinary skill in the art, the present disclosure can be applied to other similar scenarios based on these drawings without creative efforts. Unless obviously obtained from the context or the context illustrates otherwise, the same numeral in the drawings refers to the same structure or operation.

It should be understood that the terms “system,” “device,” “unit,” and/or “module” used herein are a method for distinguishing different components, elements, parts, sections, or assemblies at different levels. However, if other words can achieve the same purpose, the words may be replaced by other expressions.

As shown in the present disclosure and the claims, unless the context clearly indicates an exception, the words “a,” “an,” “one,” and/or “the” are not specifically singular and may also include plural. Generally, the terms “include” and “contain” only indicate that explicitly identified steps and elements are included, and these steps and elements do not constitute an exclusive list. A method or device may also include other steps or elements.

Flowcharts are used in the present disclosure to illustrate operations performed by a system according to embodiments of the present disclosure. It should be understood that preceding or following operations are not necessarily performed precisely in sequence. Conversely, each step may be processed in reverse order or simultaneously. Meanwhile, other operations may be added to these processes, or one or more steps may be removed from these processes.

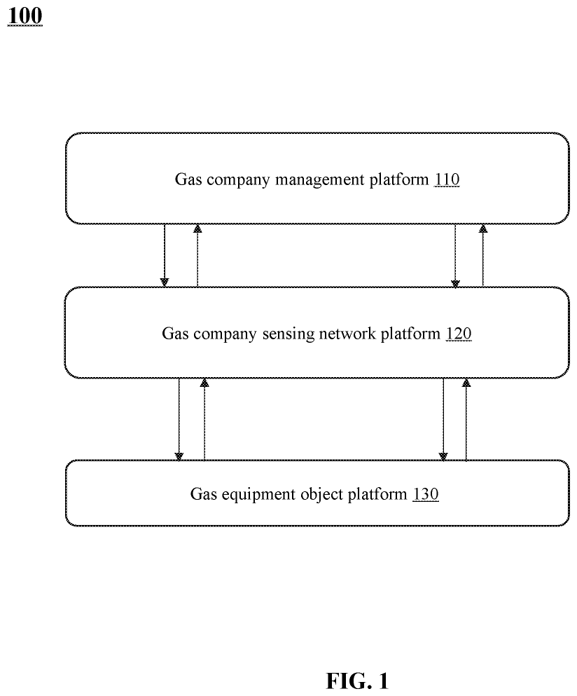

FIG. 1 is a schematic diagram of a platform structure of an Internet of Things (IoT) system for heat compensation in smart gas pipeline networks based on calorific value monitoring according to some embodiments of the present disclosure.

In some embodiments, as shown in FIG. 1, an Internet of Things system 100 for heat compensation in smart gas pipeline networks based on calorific value monitoring includes a gas company management platform 110, a gas company sensing network platform 120, and a gas equipment object platform 130.

The gas company management platform 110 refers to a platform for supervision and management by a gas company. The gas company management platform 110 is configured as a communication module, a processor, or a server. Merely by way of example, the processor includes a central processing unit (CPU), an application-specific integrated circuit (ASIC), or any combination thereof.

In some embodiments, the gas company management platform 110 interacts with the gas company sensing network platform 120. For example, the gas company management platform 110 obtains a plurality of pieces of gas monitoring data, gas usage data, gas combustion characteristics, combustion exhaust gas characteristics, and gas composition data from the gas equipment object platform 130 via the gas company sensing network platform 120.

In some embodiments, the communication module is used for communication and information transmission between various platforms and devices in the Internet of Things system 100.

By adopting the processor and the communication module, functions of automated data transmission, data processing, and automated control can be realized. The automation level of the Internet of Things-based smart gas demand guarantee system is improved. The efficiency and accuracy of gas scheduling can be improved.

The gas company sensing network platform 120 refers to a platform for managing sensing information of a gas company. The gas company sensing network platform 120 is configured as a communication device or a server. In some embodiments, the gas company sensing network platform 120 is used for communication interaction between the gas company management platform 110 and the gas equipment object platform 130.

The gas equipment object platform 130 refers to a functional platform for generating sensing information and executing control information for a gas company. The gas equipment object platform 130 is configured as a control component.

In some embodiments, the gas equipment object platform 130 includes a gas sensing device, a combustion monitoring device, and a composition detection device.

In some embodiments, the gas sensing device is disposed at at least one node in a gas pipeline network to monitor gas monitoring data of the node.

In some embodiments, the combustion monitoring device is disposed at at least one terminal node in the gas pipeline network to monitor gas usage data, gas combustion characteristics, and combustion exhaust gas characteristics of the terminal node.

In some embodiments, the composition detection device is disposed at at least one detection gate station in the gas pipeline network to detect gas composition data.

In some embodiments, the smart gas equipment object platform 130 further includes a pipeline inspection robot.

In some embodiments, the pipeline inspection robot is disposed in the gas pipeline network to crawl in a specific pipeline and collect crawling data.

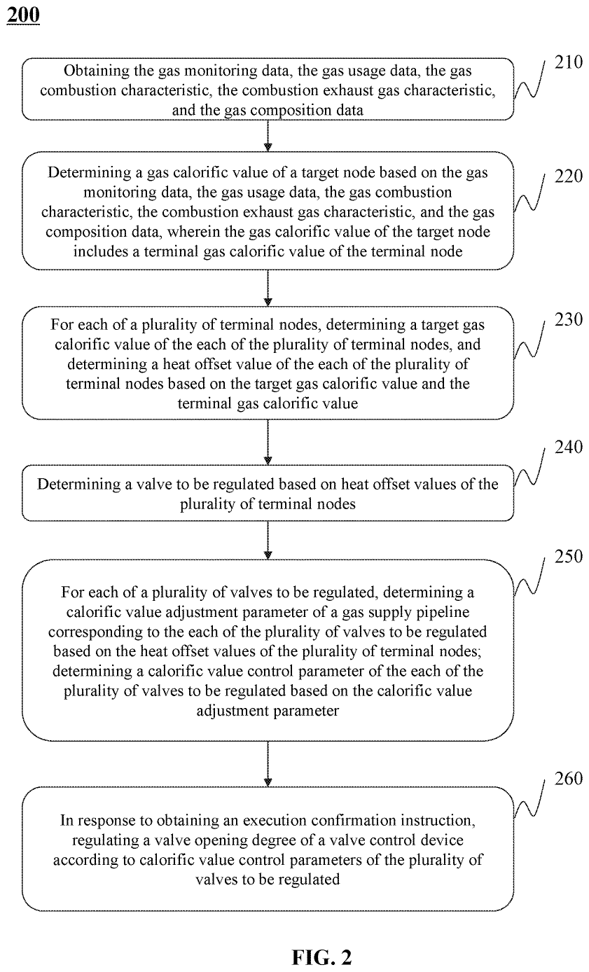

More descriptions regarding the node, the terminal node, the gas monitoring data, the gas usage data, the gas combustion characteristics, the combustion exhaust gas characteristics, the gas composition data, and the crawling data may be found in FIG. 2 and related descriptions.

In some embodiments, the smart gas equipment object platform 130 interacts bidirectionally with the gas company sensing network platform 120. For example, the smart gas equipment object platform 130 receives a scheduling instruction issued by the gas company management platform 110 via the gas company sensing network platform 120, and issues the scheduling instruction to a terminal device of a schedulable resource to control the scheduling of the schedulable resource device.

In some embodiments of the present disclosure, under the unified management of the gas company management platform 110, the Internet of Things system 100 operates in a coordinated and regular manner. The Internet of Things system 100 monitors, judges, and manages each node. Informatization and intelligence of gas heat compensation are realized.

In some embodiments of the present disclosure, an Internet of Things system for heat compensation in smart gas pipeline networks based on calorific value monitoring forms an information operation closed loop among functional platforms. The Internet of Things system for heat compensation in smart gas pipeline networks based on calorific value monitoring operates in a coordinated and regular manner under the unified management of a gas company management platform 141 to achieve informatization and intelligence for heat compensation in smart gas pipeline networks based on calorific value monitoring.

More descriptions regarding functions performed by the Internet of Things system for heat compensation in smart gas pipeline networks based on calorific value monitoring 100 may be found in related descriptions in FIG. 2 to FIG. 4 of the present disclosure.

FIG. 2 is an exemplary flowchart of a method for heat compensation in smart gas pipeline networks based on calorific value monitoring according to some embodiments of the present disclosure. In some embodiments, process 200 is executed by the gas company management platform of an Internet of Things system for heat compensation in smart gas pipeline networks based on calorific value monitoring 100. As shown in FIG. 2, process 200 includes the following steps 210 to 260.

In step 210, gas monitoring data, gas usage data, a gas combustion characteristic, a combustion exhaust gas characteristic, and gas composition data are obtained.

The gas monitoring data refers to gas data of a pipeline network node obtained by a gas sensing device. In some embodiments, the gas monitoring data includes a first gas flow velocity, a gas temperature, and a gas pressure.

The pipeline network node refers to a node in a gas pipeline network where a plurality of pipelines converge, connect, or branch. For example, the pipeline network node is a starting point of a pipeline, an ending point of a pipeline, a distribution point between pipelines, or a connection point between a pipeline and equipment (e.g., a detection gate station, a valve, a gas filling station, etc.).

In some embodiments, the pipeline network node includes a terminal node and a node other than a terminal node (i.e., an upstream node). In some embodiments, the node other than a terminal node includes a node where a detection gate station is located and other nodes (e.g., a distribution point between pipelines).

The terminal node refers to a node located at an end position (e.g., an endpoint) in the gas pipeline network, for example, a location of a final user or equipment. A user of a terminal node includes an industrial user and a commercial user.

The gas monitoring data is obtained through real-time monitoring by a gas sensing device (e.g., a pressure sensor, a temperature sensor) arranged at a pipeline network node in the gas pipeline network.

The gas usage data refers to data related to gas usage obtained at the terminal node. In some embodiments, the gas usage data includes a second gas flow velocity, a gas pressure, and a gas consumption amount.

The gas usage data is obtained through monitoring by a combustion monitoring device (e.g., a pressure sensor, a flow meter) arranged at the terminal node in the gas pipeline network.

The gas combustion characteristic refers to data related to a flame during gas combustion. In some embodiments, the gas combustion characteristic includes a flame color and a flame core temperature during gas combustion.

The gas combustion characteristic is obtained through monitoring by a combustion monitoring device (e.g., a spectrometer, a temperature sensor) arranged at the terminal node in the gas pipeline network.

The combustion exhaust gas characteristic refers to data related to exhaust gas after gas combustion. In some embodiments, the combustion exhaust gas characteristic includes an amount of exhaust gas produced after combustion, a proportion of exhaust gas components, and an instantaneous exhaust gas temperature.

The combustion exhaust gas characteristic is obtained through monitoring by a combustion monitoring device (e.g., a gas detector, a temperature sensor) arranged at the terminal node in the gas pipeline network.

The gas usage data, the gas combustion characteristic, and the combustion exhaust gas characteristic all reflect the situation of the gas calorific value of gas flowing into a terminal user. For example, an abnormal flame core temperature may indicate that a gas calorific value is low (e.g., a component proportion of gas is not ideal, etc.), requiring timely adjustment.

The gas composition data refers to data related to the composition of gas. In some embodiments, the gas composition data includes gas components and component proportions.

The gas composition data is obtained through monitoring by a composition detection device (e.g., a gas chromatograph) at the detection gate station.

More descriptions regarding the gas sensing device, the combustion monitoring device, and the composition detection device may be found in FIG. 1.

In step 220, a gas calorific value of a target node is determined based on the gas monitoring data, gas usage data, the gas combustion characteristic, the combustion exhaust gas characteristic, and the gas composition data. The gas calorific value of the target node includes a terminal gas calorific value of the terminal node.

The gas calorific value refers to the energy released when the gas is completely combusted. For example, the gas calorific value is the energy released when a certain volume or a certain mass of gas is completely combusted.

The target node refers to a node among a plurality of pipeline network nodes for which a gas calorific value needs to be determined.

In some embodiments, the target node includes the terminal node and the upstream node.

In some embodiments, the gas calorific value of the target node includes a terminal gas calorific value of a terminal node.

The terminal gas calorific value refers to an actual gas calorific value of the terminal node.

In some embodiments, the terminal gas calorific value is determined based on the gas usage data, the gas combustion characteristic, and the combustion exhaust gas characteristic.

In some embodiments, the gas company management platform determines the terminal gas calorific value by querying a first preset lookup table based on current gas usage data, a current gas combustion characteristic, and a current combustion exhaust gas characteristic. The first preset lookup table includes a correspondence relationship among the gas usage data, the gas combustion characteristic, the combustion exhaust gas characteristic, and a reference terminal gas calorific value. A matched reference terminal gas calorific value is determined as the terminal gas calorific value.

The first preset lookup table is constructed based on prior knowledge or historical data. For example, the gas usage data, the gas combustion characteristic, and the combustion exhaust gas characteristic in the first preset lookup table are historical data; the reference terminal gas calorific value is an actual gas calorific value corresponding to the historical data.

In some embodiments, the actual gas calorific value (the reference terminal gas calorific value) corresponding to historical data is determined in various ways. For example, for a terminal node from which a gas sample can be obtained, one or more combustion tests are performed on the obtained gas sample, and the reference terminal gas calorific value is determined through the combustion test. When a count of the combustion tests is a plurality of times, a mode or an average of actual gas calorific values obtained from a plurality of combustion tests is determined as the reference terminal gas calorific value.

In some embodiments, the gas calorific value of a target node includes a gas calorific value of an upstream node.

In some embodiments, the gas company management platform determines the gas calorific value of the upstream node by querying a second preset lookup table based on gas composition data. The second preset lookup table includes a correspondence relationship between the gas composition data and the gas calorific value. The second preset lookup table is constructed based on prior knowledge or historical data.

In some embodiments, the upstream node includes a node where a detection gate station is located and other nodes. In some embodiments, for the node where the detection gate station is located, the gas company management platform determines the gas calorific value of the upstream node by querying the second preset lookup table based on gas composition data acquired by a composition detection device disposed at the detection gate station.

In some embodiments, for other nodes (nodes where no composition detection device is disposed), the gas company management platform obtains at least two detection gate stations that are closest to the other node, which are on at least one gas pipeline where the upstream node is located, and determines the gas calorific value of the upstream node based on gas calorific values of the nodes of the at least two detection gate stations. For example, an average of the gas calorific values of the nodes of the at least two detection gate stations is determined as the gas calorific value of the upstream node.

In some embodiments, for other nodes (nodes where no composition detection device is disposed), the gas calorific value of the upstream node is further related to pipeline distances from the upstream node to the aforementioned at least two detection gate stations. Merely by way of example, the gas calorific value of the upstream node is determined in the following manner.

The gas calorific value of the upstream node=a gas calorific value of detection gate station A+a pipeline length between detection gate station A and the upstream node * (the gas calorific value of detection gate station A-a gas calorific value of detection gate station B)/(a pipeline length between detection gate station A and detection gate station B).

The detection gate station A and the detection gate station B are located on the same gas pipeline as the upstream node and are the two detection gate stations closest to the upstream node, and the detection gate station A is located upstream of the detection gate station B.

The pipeline length between detection gate stations is preset by a technician.

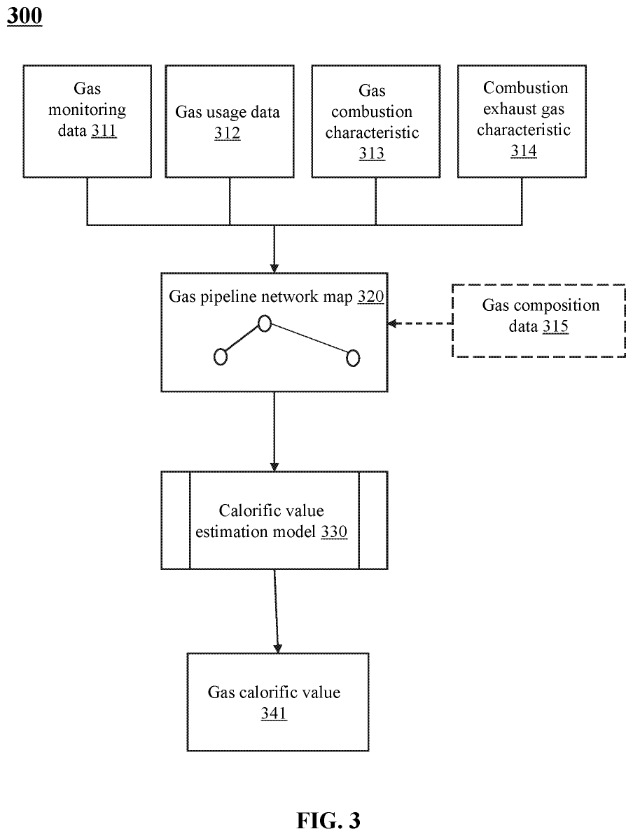

In some embodiments, the gas company management platform further determines the gas calorific value of the target node based on a gas pipeline network map through a calorific value estimation model. More descriptions of this part may be found in the related description of FIG. 3.

In step 230, for each of a plurality of terminal nodes, a target gas calorific value of each of the plurality of terminal nodes is determined, and a heat offset value of each of the plurality of terminal nodes is determined based on the target gas calorific value and the terminal gas calorific value.

The target gas calorific value refers to a gas calorific value that the terminal node needs to achieve. The target gas calorific value is preset.

The heat offset value refers to a difference between the current gas calorific value (e.g., the terminal gas calorific value) and the target gas calorific value.

In step 240, a valve to be regulated is determined based on the heat offset values of the plurality of terminal nodes.

The valve to be regulated refers to a valve that needs to be regulated to change the terminal gas calorific value.

In some embodiments, the gas company management platform uses a terminal node whose heat offset value is greater than a preset threshold as a node to be regulated. For each of a plurality of nodes to be regulated, a regulatable valve closest to the node to be regulated is used as the valve to be regulated, thereby determining a plurality of valves to be regulated. The preset threshold is preset by an end user.

In step 250, for each of the plurality of valves to be regulated, a calorific value adjustment parameter of a gas supply pipeline corresponding to the each of the plurality of valves to be regulated is determined based on the heat offset values of the plurality of terminal nodes; and a calorific value control parameter of the each of the plurality of valves to be regulated is determined based on the calorific value adjustment parameter.

The calorific value adjustment parameter refers to an adjustment parameter of a gas supply pipeline. For example, the calorific value adjustment parameter is that the gas supply pipeline C needs to increase the gas calorific value by X joules.

In some embodiments, for each of the plurality of valves to be regulated, the gas company management platform determines the calorific value adjustment parameter of a gas supply pipeline corresponding to the valve to be regulated by querying a third preset lookup table based on heat offset values of the plurality of terminal nodes. The third preset lookup table includes a correspondence relationship between the heat offset value and the calorific value adjustment parameter. The third preset lookup table is constructed based on prior knowledge or experiments.

In some embodiments, a valve to be regulated controls one gas supply pipeline or a plurality of gas supply pipelines.

In some embodiments, when the valve to be regulated controls one gas supply pipeline (i.e., corresponding to a heat offset value of one terminal node), the calorific value adjustment parameter of the gas supply pipeline corresponding to the valve to be regulated is one. In some embodiments, when the valve to be regulated controls a plurality of gas supply pipelines (i.e., corresponding to heat offset values of a plurality of terminal nodes), the heat offset value of each terminal node determines one calorific value adjustment parameter, and calorific value adjustment parameters of the gas supply pipeline corresponding to the valve to be regulated include a plurality of calorific value adjustment parameters. It can be understood that each terminal node corresponds to one gas supply pipeline.

In some embodiments of the present disclosure, because the valve to be regulated may control a plurality of gas supply pipelines, comprehensive regulation based on conditions of the plurality of gas supply pipelines can enable a plurality of terminal nodes to achieve a target gas calorific value as much as possible.

The calorific value control parameter refers to a control parameter of the valve to be regulated. In some embodiments, the calorific value control parameter at least includes a valve control device corresponding to the valve to be regulated and a valve opening degree of the valve control device. The valve control device refers to a device for controlling the valve. For example, when the valve is a solenoid valve, the valve control device is a processor communicatively connected to the solenoid valve. As another example, the valve control device is a driving device (e.g., a motor) connected to the valve, and the driving device controls the valve opening degree of the valve.

In some embodiments, the gas company management platform determines the calorific value control parameter of the valve to be regulated by weighted summation based on calorific value adjustment parameters of at least one gas supply pipeline.

As mentioned above, the calorific value adjustment parameter of a gas supply pipeline corresponding to one valve to be regulated may include a plurality of calorific value adjustment parameters. In some embodiments, a weight of the calorific value adjustment parameter of the gas supply pipeline of the valve to be regulated corresponding to each terminal node is negatively correlated with the quantity of valves existing between the valve to be regulated and the terminal node.

When other valves (e.g., non-adjustable valves) exist between the valve to be regulated and the terminal node, the regulation of the valve to be regulated does not play a decisive role for the terminal node, and the weight of the calorific value adjustment parameter of the gas supply pipeline of the valve to be regulated is reduced.

In step 260, in response to obtaining an execution confirmation instruction, the valve opening degree of a valve control device is regulated according to calorific value control parameters of the plurality of valves to be regulated.

The execution confirmation instruction refers to a confirmation instruction related to valve regulation.

The valve opening degree refers to an opening degree of the valve to be regulated of the valve control device. In some embodiments, a larger opening degree of the valve to be regulated corresponds to a larger gas calorific value.

In some embodiments of the present disclosure, during a process of transmitting gas in a gas pipeline network, situations such as pipeline impurities, mixing of multi-source gas, vaporization or liquefaction of combustible components due to temperature and pressure changes may cause instability of a gas calorific value. The instability of the gas calorific value leads to non-uniform gas calorific values for various terminal users, thereby causing trouble to the users. By regulating the gas calorific value, a gas calorific value of a terminal user meets a requirement, product quality and user experience can be improved, and consumer rights can be maintained.

It should be noted that the above description of process 200 is merely for illustration and explanation, and does not limit the applicable scope of the present disclosure. For those skilled in the art, various modifications and changes to process 200 can be made under the guidance of the present disclosure. However, these modifications and changes are still within the scope of the present disclosure.

FIG. 3 is an exemplary flowchart of a calorific value estimation model according to some embodiments of the present disclosure.

In some embodiments, the gas company management platform constructs a gas pipeline network map 320 and determines a gas calorific value 341 of a target node through a calorific value estimation model 330 based on the gas pipeline network map 320.

The gas pipeline network map 320 is a map reflecting the overall structure of a gas pipeline network.

In some embodiments, the gas pipeline network map 320 includes a plurality of map nodes and a plurality of edges. The map node corresponds to the target node and includes the terminal node and an upstream node. A node characteristic of the terminal node includes the gas usage data 312, the gas combustion characteristics 313, the combustion exhaust gas characteristics 314, and the gas monitoring data 311. A node characteristic of an upstream node includes the gas monitoring data 311. The edge corresponds to a gas pipeline between map nodes. An edge characteristic includes at least one of a pipeline length, an inner diameter, an inner wall material, a service life, or an interval since last cleaning.

For example, the map nodes of the gas pipeline network map correspond to various target nodes of the gas pipeline network, and the node characteristics are obtained by a gas sensing device and a combustion monitoring device at target nodes. Between two target nodes having a gas pipeline, an edge exists. The edge characteristics include a pipeline length, an inner diameter, an inner wall material, a service life, and an interval since last cleaning corresponding to the gas pipeline. The edge characteristics are preset by a technician or obtained in real time from the smart gas equipment object platform. For more descriptions about the terminal node, the upstream node, the gas usage data, etc., please refer to the content of FIG. 2.

In some embodiments, the node characteristics further include gas composition data 315. For example, when the upstream node is a node where the detection gate station is located, corresponding node characteristics include gas composition data 315.

In some embodiments, the edge characteristics further include deposit characteristics. For more descriptions about the deposit characteristics, please refer to the following content.

For node characteristics corresponding to a map node where the detection gate station is not set, a value of the gas composition data 315 in the node characteristics is set to a null value. For edge characteristics corresponding to an edge without deposit characteristics, a value of the deposit characteristics in the edge characteristics is set to a null value.

In some embodiments, the smart gas equipment object platform further includes a pipeline inspection robot. In some embodiments, the gas company management platform controls the pipeline inspection robot to crawl in a gas pipeline and to collect crawling data based on a crawling instruction in response to receiving the crawling instruction. The gas company management platform determines the deposit characteristics based on the crawling data of the gas pipeline corresponding to an edge to which the edge characteristic belongs.

The crawling instruction refers to an operation instruction of the pipeline inspection robot.

The crawling data refers to data collected by the pipeline inspection robot in the target pipeline.

In some embodiments, the crawling data includes a sequence of center-of-gravity positions and a sequence of attitudes during a process of the pipeline inspection robot moving forward along an inner wall of the pipeline.

The sequence of center-of-gravity positions refers to a sequence composed of center-of-gravity positions of the pipeline inspection robot during an advancing process. The sequence of attitudes refers to a sequence composed of attitudes (e.g., an orientation of the pipeline inspection robot moving forward) of the pipeline inspection robot during the advancing process.

The deposit characteristics refer to characteristics related to deposits on the inner wall of the pipeline. The deposit characteristics include a composition of deposits and a proportion of the composition.

The gas company management platform determines the deposit characteristics by querying a fourth preset lookup table based on the center-of-gravity position sequence and the attitude sequence. The fourth preset lookup table includes a correspondence relationship among the center-of-gravity position sequence, the attitude sequence, and the deposit characteristics. The fourth preset lookup table is constructed based on prior knowledge or experiments. For example, for pipelines with various deposit characteristics, the pipeline inspection robot is controlled to perform actual crawling to obtain crawling data, and the fourth preset lookup table is constructed accordingly.

In some embodiments of the present disclosure, for some pipelines that may be blocked or have a poor internal environment, by obtaining the crawling data through the pipeline inspection robot, deposit conditions inside the pipeline can be inferred. Accordingly, conditions inside the pipeline can be obtained. The accuracy of subsequent gas calorific value regulation can be improved. The regulation result can be made to conform to actual conditions.

In some embodiments, the determining the deposit characteristics based on the crawling data of the gas pipeline corresponding to an edge to which the edge characteristic belongs includes: for each piece of crawling data, in response to the crawling data satisfying a preset condition, adjusting a crawling speed of the pipeline inspection robot in the gas pipeline corresponding to the edge to which the edge characteristic belongs based on the crawling data. The preset condition relates to a coefficient of variation of the crawling data. The pipeline inspection robot is controlled to re-crawl at the adjusted crawling speed in the gas pipeline corresponding to the edge and collect supplementary crawling data. The deposit characteristic is determined through a characteristic estimation model based on the supplementary crawling data. The characteristic estimation model is a machine learning model.

The preset condition is that the center-of-gravity position sequence is below a center-of-gravity threshold. The center-of-gravity threshold is preset.

The coefficient of variation refers to a coefficient that indicates whether the crawling data is abnormal. For example, the coefficient of variation refers to a coefficient of dispersion of the center-of-gravity position sequence or the attitude sequence. In some embodiments, the preset condition is that the coefficient of variation of the crawling data is greater than an abnormality threshold. The abnormality threshold is preset.

In some embodiments, in response to the crawling data satisfying the preset condition, the gas company management platform reduces the crawling speed of the pipeline inspection robot in the gas pipeline corresponding to the edge to which the edge characteristics belong.

It can be understood that when the crawling data of the pipeline inspection robot indicates that the coefficient of variation is too large, it indicates that the pipeline has many deposits, or the pipeline inspection robot is operating unstably. In this case, the crawling speed of the pipeline inspection robot may be set too fast. Appropriately reducing the crawling speed can stabilize the operation of the pipeline inspection robot. The crawling data can be collected more precisely. Accordingly, the deposit characteristics can be obtained more accurately.

The supplementary crawling data is crawling data collected by the pipeline inspection robot after the crawling speed is adjusted.

The characteristic estimation model refers to a model used to determine the deposit characteristics. In some embodiments, the characteristic estimation model is a machine learning model. For example, the machine learning model is a recurrent neural network (RNN) or the like.

An input of the characteristic estimation model includes the supplementary crawling data. An output of the characteristic estimation model is the deposit characteristics.

In some embodiments, the characteristic estimation model is obtained by training with a plurality of first samples. Each of the plurality of first samples includes sample supplementary crawling data. A first label corresponding to the first sample is an actual deposit characteristic of the sample supplementary crawling data. The first sample is historical supplementary crawling data or historical crawling data. The first label is an actual deposit characteristic detected subsequently (e.g., during maintenance), corresponding to the historical supplementary crawling data or the historical crawling data.

In some embodiments, the gas company management platform trains the characteristic estimation model based on a plurality of first samples with the first labels.

In some embodiments, the gas company management platform obtains a training dataset. The training dataset includes a plurality of first samples with the first labels. Training the characteristic estimation model includes performing a plurality of rounds of iterative training. At least one round of iterative training includes: selecting one or more first samples from the training dataset; inputting the one or more first samples into an initial characteristic estimation model to obtain model output results corresponding to the one or more first samples; constructing a loss function based on the output results and the first labels, and updating the initial characteristic estimation model based on the loss function, for example, updating based on a gradient descent way. When a preset training condition is satisfied, training of the initial characteristic estimation model is completed, and a trained characteristic estimation model is obtained. The preset training condition includes convergence of the loss function, a count of iterations reaching a threshold, or the like.

In some embodiments of the present disclosure, by determining the deposit characteristics through the characteristic estimation model, a large amount of data can be processed and analyzed in real time. Accordingly, the deposit characteristics can be determined quickly and accurately.

In some embodiments, the gas company management platform determines the gas calorific value 341 of the target node through a calorific value estimation model 330 based on the gas pipeline network map 320.

The calorific value estimation model 330 is a model used to determine the gas calorific value 341 of the target node. In some embodiments, the calorific value estimation model 330 is a graph neural network model (GNN) or the like.

In some embodiments, an input of the calorific value estimation model 330 is the gas pipeline network map 320. An output of the calorific value estimation model 330 includes the gas calorific value 341 of the target node.

In some embodiments, the calorific value estimation model 330 is obtained by training with a plurality of second samples. Each of the plurality of second samples includes a sample gas pipeline network map. A second label corresponding to the second sample is an actual gas calorific value. The second sample is a gas pipeline network map in historical data. The second label is an actual gas calorific value. A way for determining the second label is the same as the way for determining the actual gas calorific value corresponding to the historical data (referring to the terminal gas calorific value) described above, and details are not repeated here.

In some embodiments, the gas company management platform trains the calorific value estimation model 330 based on the plurality of second samples, including the second labels. The training process of the calorific value estimation model 330 is similar to the training process of the characteristic estimation model, which can be referred to above, and details are not repeated here.

In some embodiments of the present disclosure, the gas calorific value is closely related to the gas composition data. However, exploration of the gas composition data is difficult and costly. Therefore, it is not feasible to equip each node with a composition detection device. The gas calorific value of each node is predicted through a graph model based on composition detection devices installed at some nodes and the constructed gas pipeline network map that reflects the structure of the entire pipeline network. Accordingly, calorific values of all nodes can be obtained at low cost, quickly, conveniently, and efficiently.

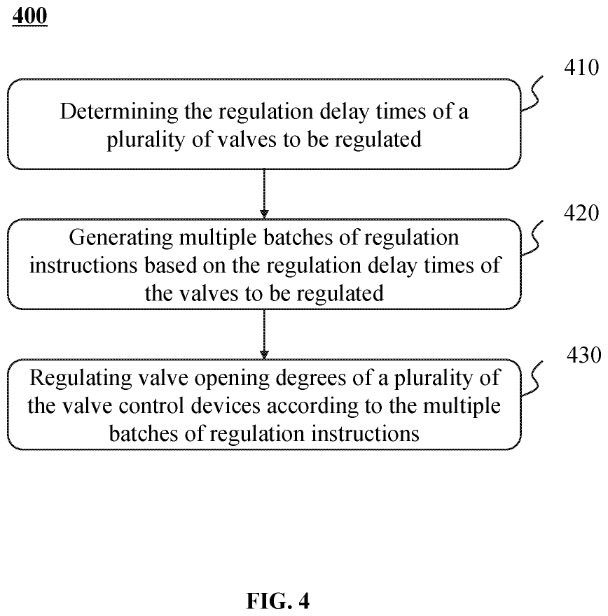

FIG. 4 is an exemplary flowchart for regulating a valve opening degree according to some embodiments of the present disclosure.

In step 410, the regulation delay times of a plurality of valves to be regulated are determined.

The regulation delay time refers to a time interval from a time node when regulation is performed on an upstream valve corresponding to a terminal to a time node when a calorific value of the terminal changes after the regulation of the upstream valve.

In some embodiments, for each of the plurality of valves to be regulated, the regulation delay time t of each valve to be regulated is determined by the following formula (1):

$$t = \frac{l}{v} , \qquad ( 1 )$$

where l denotes a pipeline length of a pipeline from the valve to be regulated to the terminal, and v denotes a gas flow velocity in the pipeline from the valve to be regulated to the terminal.

In some embodiments, if one valve to be regulated corresponds to a plurality of terminals, the largest regulation delay time among a plurality of regulation delay times t corresponding to the valve to be regulated is used as the regulation delay time of the valve to be regulated.

In some embodiments, the gas company management platform determines the regulation delay time of a map node corresponding to the valve to be regulated through a calorific value estimation model based on the gas pipeline network map. The calorific value estimation model is a graph neural network model. The gas pipeline network map includes a map node and an edge. The map node corresponds to the target node and includes the terminal node and an upstream node. A node characteristic of the terminal node includes the gas usage data, the gas combustion characteristic, the combustion exhaust gas characteristic, and the gas monitoring data. A node characteristic of the upstream node includes the gas monitoring data, and the edge corresponds to a gas pipeline between map nodes. An edge characteristic includes at least one of a pipeline length, an inner diameter, an inner wall material, a service life, or an interval since last cleaning.

In some embodiments, an output of the calorific value estimation model 330 further includes the regulation delay time of the map node corresponding to the valve to be regulated.

In some embodiments, the second label corresponding to the second sample further includes an actual regulation delay time of the map node corresponding to the valve to be regulated, corresponding to the second sample. In some embodiments, the actual regulation delay time is obtained by timing using a timer.

More descriptions about the gas pipeline network map and the calorific value estimation model may be found in FIG. 3 and the related description.

In some embodiments of the present disclosure, because a pipeline network is a very large system, regulations are not independent of each other. By constructing the gas pipeline network map and using the calorific value estimation model 330, the complex physical structure of the pipeline network can be considered, so that the regulation delay time can be determined more accurately.

In step 420, multiple batches of regulation instructions are generated based on the regulation delay times of the valves to be regulated.

The multiple batches of regulation instructions refer to a plurality of groups of regulation instructions executed by the gas company management platform at a plurality of time points. Each group of regulation instructions includes at least one regulation instruction. The regulation instruction refers to a machine instruction for controlling the valve to be regulated. In some embodiments, the regulation instruction includes the plurality of valves to be regulated and the valve opening degrees corresponding to the plurality of valves to be regulated at the plurality of time points.

In some embodiments, the gas company management platform determines a time for regulating each of the plurality of valves to be regulated according to the regulation delay times of the plurality of valves to be regulated, and determines the valve opening degree of the valve to be regulated according to the calorific value control parameter. The valves to be regulated that have the same time for regulation are regulated using the same batch of instructions, thereby generating multiple batches of regulation instructions. More descriptions about the calorific value control parameter may be found in FIG. 2 and the related description.

In step 430, valve opening degrees of a plurality of the valve control devices are regulated according to the multiple batches of regulation instructions.

In some embodiments, the gas company management platform controls the opening of the plurality of valve control devices at the plurality of time points according to a batch of regulation instructions at the time point, so that the plurality of valve control devices are opened to a specific degree.

In some embodiments, because the pipeline network is a very large system, regulation for a local part of the pipeline network does not take effect immediately. Performing batch-wise control for the positions where the valves are located can most efficiently ensure that the terminal gas calorific value meets requirements as soon as possible.

The basic concepts have been described above. Obviously, for those skilled in the art, the above detailed disclosure is merely an example and does not constitute a limitation on the present disclosure. Although not explicitly stated herein, those skilled in the art may make various modifications, improvements, and corrections to the present disclosure. Such modifications, improvements, and corrections are suggested in the present disclosure, so such modifications, improvements, and corrections still belong to the spirit and scope of the exemplary embodiments of the present disclosure.

Meanwhile, the present disclosure uses specific words to describe the embodiments of the present disclosure. For example, “an embodiment,” “one embodiment,” and/or “some embodiments” mean a certain feature, structure, or characteristic related to at least one embodiment of the present disclosure. Therefore, it should be emphasized and noted that “an embodiment” or “one embodiment” or “an alternative embodiment” mentioned two or more times in different places in the present disclosure does not necessarily refer to the same embodiment. In addition, certain features, structures, or characteristics in one or more embodiments of the present disclosure may be appropriately combined.

In addition, unless explicitly stated in the claims, the order of processing elements and sequences, the use of numbers and letters, or the use of other names in the present disclosure is not used to limit the order of processes and methods of the present disclosure. Although the foregoing disclosure discusses some embodiments of the invention currently considered useful through various examples, it should be understood that such details are for illustrative purposes only, and the appended claims are not limited to the disclosed embodiments. On the contrary, the claims are intended to cover all modifications and equivalent combinations that conform to the essence and scope of the embodiments of the present disclosure. For example, although the implementation of various components described above may be embodied in a hardware device, it may also be implemented as a software only solution, e.g., an installation on an existing server or mobile device.

Similarly, it should be noted that, in order to simplify the expression disclosed in the present disclosure to help understand one or more embodiments of the invention, multiple features are sometimes grouped into one embodiment, drawing, or description thereof in the foregoing description of the embodiments of the present disclosure. However, this disclosure method does not mean that the object of the present disclosure requires more features than the features mentioned in the claims. Rather, claimed subject matter may lie in less than all features of a single foregoing disclosed embodiment.

In some embodiments, numbers describing components and attribute quantities are used. It should be understood that such numbers used to describe the embodiments are modified by the modifiers “about,” “approximately,” or “substantially” in some examples. Unless otherwise stated, “about,” “approximately,” or “substantially” indicates that the number allows a variation of +20%. Accordingly, in some embodiments, the numerical parameters used in the specification and claims are approximate values, and the approximate values may vary according to the characteristics required by individual embodiments. In some embodiments, numerical parameters should consider the specified count of significant digits and adopt a general way of digit retention. Although the numerical ranges and parameters used to confirm the breadth of the scope in some embodiments of the present disclosure are approximate values, such numerical values are set as accurately as possible within a feasible range in specific embodiments.

For each patent, patent application, patent application publication, and other material, such as articles, books, specifications, publications, documents, etc., cited in the present disclosure, the entire content of the patent, patent application, patent application publication, and other material is hereby incorporated into the present disclosure by reference. Application history documents that are inconsistent with or conflict with the content of the present disclosure are excluded, and documents that limit the broadest scope of the claims of the present disclosure (currently or subsequently attached to the present disclosure) are also excluded. It should be noted that, if the description, definition, and/or use of terms in the supplementary materials of the present disclosure are inconsistent with or conflict with the content described in the present disclosure, the description, definition, and/or use of terms in the present disclosure shall prevail.

Finally, it should be understood that the embodiments described in the present disclosure are only used to illustrate the principles of the embodiments of the present disclosure. Other variations may also fall within the scope of the present disclosure. Therefore, by way of example and not limitation, alternative configurations of the embodiments of the present disclosure may be considered consistent with the teachings of the present disclosure. Accordingly, the embodiments of the present disclosure are not limited to the embodiments explicitly introduced and described in the present disclosure.

What is claimed is:

1. An Internet of Things (IoT) system for heat compensation in smart gas pipeline networks based on calorific value monitoring, comprising: a gas company sensing network platform, a smart gas equipment object platform, and a gas company management platform; wherein
the smart gas equipment object platform includes at least one of a gas sensing device, a combustion monitoring device, or a composition detection device, wherein the gas sensing device is disposed at a pipeline network node in a gas pipeline network to monitor gas monitoring data of the pipeline network node, the combustion monitoring device is disposed at a terminal node to monitor gas usage data, a gas combustion characteristic, and a combustion exhaust gas characteristic of the terminal node, and the composition detection device is disposed at a detection gate station to detect gas composition data of the detection gate station;
the gas company management platform is configured to:
obtain the gas monitoring data, the gas usage data, the gas combustion characteristic, the combustion exhaust gas characteristic, and the gas composition data from the smart gas equipment object platform via the gas company sensing network platform;
determine a gas calorific value of a target node based on the gas monitoring data, the gas usage data, the gas combustion characteristic, the combustion exhaust gas characteristic, and the gas composition data, wherein the gas calorific value of the target node includes a terminal gas calorific value of the terminal node, and the terminal gas calorific value is determined based on the gas usage data, the gas combustion characteristic, and the combustion exhaust gas characteristic;
for each of a plurality of terminal nodes, determine a target gas calorific value of the each of the plurality of terminal nodes, and determine a heat offset value of the each of the plurality of terminal nodes based on the target gas calorific value and the terminal gas calorific value;
determine a valve to be regulated based on heat offset values of the plurality of terminal nodes;
for each of a plurality of valves to be regulated:
determine a calorific value adjustment parameter of a gas supply pipeline corresponding to the each of the plurality of valves to be regulated based on the heat offset values of the plurality of terminal nodes;
determine a calorific value control parameter of the each of the plurality of valves to be regulated based on the calorific value adjustment parameter; and
in response to obtaining an execution confirmation instruction, regulate a valve opening degree of a valve control device according to calorific value control parameters of the plurality of valves to be regulated.

2. The IoT system according to claim 1, wherein the gas company management platform is further configured to:
construct a gas pipeline network map including a map node and an edge, wherein the map node corresponds to the target node and includes the terminal node and an upstream node, a node characteristic of the terminal node includes the gas usage data, the gas combustion characteristic, the combustion exhaust gas characteristic, and the gas monitoring data, a node characteristic of the upstream node includes the gas monitoring data, the edge corresponds to a gas pipeline between map nodes, and an edge characteristic includes at least one of a pipeline length, an inner diameter, an inner wall material, a service life, or an interval since last cleaning; and
determine the gas calorific value of the target node through a calorific value estimation model based on the gas pipeline network map, wherein the calorific value estimation model is a graph neural network model.

3. The IoT system according to claim 2, wherein the smart gas equipment object platform further includes a pipeline inspection robot, wherein
the pipeline inspection robot is configured to, in response to receiving a crawling instruction, crawl in a gas pipeline and collect crawling data based on the crawling instruction;
wherein the edge characteristic further includes a deposit characteristic, and the deposit characteristic is determined based on the crawling data of the gas pipeline corresponding to the edge to which the edge characteristic belongs.

4. The IoT system according to claim 3, wherein the gas company management platform is further configured to:
for the crawling data, in response to the crawling data satisfying a preset condition, adjust a crawling speed of the pipeline inspection robot in the gas pipeline corresponding to the edge to which the edge characteristic belongs based on the crawling data, wherein the preset condition relates to a coefficient of variation of the crawling data;
control the pipeline inspection robot to re-crawl at an adjusted crawling speed in the gas pipeline corresponding to the edge and collect supplementary crawling data; and
determine the deposit characteristic through a characteristic estimation model based on the supplementary crawling data, wherein the characteristic estimation model is a machine learning model.

5. The IoT system according to claim 1, wherein the calorific value control parameter further includes a regulation delay time of the valve to be regulated, and the gas company management platform is further configured to:
determine regulation delay times of the plurality of valves to be regulated;
generate multiple batches of regulation instructions based on the regulation delay times of the plurality of valves to be regulated; and
regulate valve opening degrees of a plurality of valve control devices according to the multiple batches of regulation instructions.

6. The IoT system according to claim 5, wherein the gas company management platform is further configured to:
determine the regulation delay time of a map node corresponding to the valve to be regulated through a calorific value estimation model based on a gas pipeline network map, wherein the calorific value estimation model is a graph neural network model, the gas pipeline network map includes the map node and an edge, wherein the map node corresponds to the target node and includes the terminal node and an upstream node, a node characteristic of the terminal node includes the gas usage data, the gas combustion characteristic, the combustion exhaust gas characteristic, and the gas monitoring data, a node characteristic of the upstream node includes the gas monitoring data, the edge corresponds to a gas pipeline between map nodes, and an edge characteristic includes at least one of a pipeline length, an inner diameter, an inner wall material, a service life, or an interval since last cleaning.

7. A method for heat compensation in smart gas pipeline networks based on calorific value monitoring, wherein the method is implemented by a gas company management platform of an Internet of Things (IoT) system for heat compensation in smart gas pipeline networks based on calorific value monitoring, and the IoT system includes a gas company sensing network platform, a smart gas equipment object platform, and the gas company management platform; wherein
the smart gas equipment object platform includes at least one of a gas sensing device, a combustion monitoring device, or a composition detection device, wherein the gas sensing device is disposed at a pipeline network node in a gas pipeline network to monitor gas monitoring data of the pipeline network node, the combustion monitoring device is disposed at a terminal node to monitor gas usage data, a gas combustion characteristic, and a combustion exhaust gas characteristic of the terminal node, and the composition detection device is disposed at a detection gate station to detect gas composition data of the detection gate station; wherein
the method comprises:
obtaining the gas monitoring data, the gas usage data, the gas combustion characteristic, the combustion exhaust gas characteristic, and the gas composition data;
determining a gas calorific value of a target node based on the gas monitoring data, the gas usage data, the gas combustion characteristic, the combustion exhaust gas characteristic, and the gas composition data, wherein the gas calorific value of the target node includes a terminal gas calorific value of the terminal node, and the terminal gas calorific value is determined based on the gas usage data, the gas combustion characteristic, and the combustion exhaust gas characteristic;
for each of a plurality of terminal nodes, determining a target gas calorific value of the each of the plurality of terminal nodes, and determining a heat offset value of the each of the plurality of terminal nodes based on the target gas calorific value and the terminal gas calorific value;
determining a valve to be regulated based on heat offset values of the plurality of terminal nodes;
for each of a plurality of valves to be regulated:
determining a calorific value adjustment parameter of a gas supply pipeline corresponding to the each of the plurality of valves to be regulated based on the heat offset values of the plurality of terminal nodes;
determining a calorific value control parameter of the each of the plurality of valves to be regulated based on the calorific value adjustment parameter; and
in response to obtaining an execution confirmation instruction, regulating a valve opening degree of a valve control device according to calorific value control parameters of the plurality of valves to be regulated.

8. The method according to claim 7, wherein the determining a gas calorific value of a target node based on the gas monitoring data, the gas usage data, the gas combustion characteristic, the combustion exhaust gas characteristic, and the gas composition data comprises:
constructing a gas pipeline network map including a map node and an edge, wherein the map node corresponds to the target node and includes the terminal node and an upstream node, a node characteristic of the terminal node includes the gas usage data, the gas combustion characteristic, the combustion exhaust gas characteristic, and the gas monitoring data, a node characteristic of the upstream node includes the gas monitoring data, the edge corresponds to a gas pipeline between map nodes, and an edge characteristic includes at least one of a pipeline length, an inner diameter, an inner wall material, a service life, or an interval since last cleaning; and
determining the gas calorific value of the target node through a calorific value estimation model based on the gas pipeline network map, wherein the calorific value estimation model is a graph neural network model.

9. The method according to claim 8, wherein the smart gas equipment object platform further includes a pipeline inspection robot, the edge characteristic further includes a deposit characteristic, and the method further comprises:
in response to receiving a crawling instruction, controlling the pipeline inspection robot to crawl in a gas pipeline and collect crawling data based on the crawling instruction; and
determining the deposit characteristic based on the crawling data of the gas pipeline corresponding to the edge to which the edge characteristic belongs.

10. The method according to claim 9, wherein the determining the deposit characteristic based on the crawling data of the gas pipeline corresponding to the edge to which the edge characteristic belongs comprises:
for the crawling data, in response to the crawling data satisfying a preset condition, adjusting a crawling speed of the pipeline inspection robot in the gas pipeline corresponding to the edge to which the edge characteristic belongs based on the crawling data, wherein the preset condition relates to a coefficient of variation of the crawling data;
controlling the pipeline inspection robot to re-crawl at an adjusted crawling speed in the gas pipeline corresponding to the edge to which the edge characteristic belongs and collecting supplementary crawling data; and
determining the deposit characteristic through a characteristic estimation model based on the supplementary crawling data, wherein the characteristic estimation model is a machine learning model.

11. The method according to claim 7, wherein the calorific value control parameter further includes a regulation delay time of the valve to be regulated, and the method further comprises:
determining regulation delay times of the plurality of valves to be regulated;
generating multiple batches of regulation instructions based on the regulation delay times of the plurality of valves to be regulated; and
regulating valve opening degrees of a plurality of valve control devices according to the multiple batches of regulation instructions.

12. The method according to claim 11, further comprising:
determining the regulation delay time of a map node corresponding to the valve to be regulated through a calorific value estimation model based on a gas pipeline network map, wherein the calorific value estimation model is a graph neural network model, the gas pipeline network map includes the map node and an edge, wherein the map node corresponds to the target node and includes the terminal node and an upstream node, a node characteristic of the terminal node includes the gas usage data, the gas combustion characteristic, the combustion exhaust gas characteristic, and the gas monitoring data, a node characteristic of the upstream node includes the gas monitoring data, the edge corresponds to a gas pipeline between map nodes, and an edge characteristic includes at least one of a pipeline length, an inner diameter, an inner wall material, a service life, or an interval since last cleaning.

13. A non-transitory computer-readable storage medium, wherein the storage medium stores computer instructions, and when a computer reads the computer instructions in the storage medium, the computer executes a method for heat compensation in smart gas pipeline networks based on calorific value monitoring, wherein the method is implemented by a gas company management platform of an Internet of Things (IoT) system for heat compensation in smart gas pipeline networks based on calorific value monitoring, and the IoT system includes a gas company sensing network platform, a smart gas equipment object platform, and the gas company management platform; wherein
the smart gas equipment object platform includes at least one of a gas sensing device, a combustion monitoring device, or a composition detection device, wherein the gas sensing device is disposed at a pipeline network node in a gas pipeline network to monitor gas monitoring data of the pipeline network node, the combustion monitoring device is disposed at a terminal node to monitor gas usage data, a gas combustion characteristic, and a combustion exhaust gas characteristic of the terminal node, and the composition detection device is disposed at a detection gate station to detect gas composition data of the detection gate station; wherein
the method comprises:
obtaining the gas monitoring data, the gas usage data, the gas combustion characteristic, the combustion exhaust gas characteristic, and the gas composition data;
determining a gas calorific value of a target node based on the gas monitoring data, the gas usage data, the gas combustion characteristic, the combustion exhaust gas characteristic, and the gas composition data, wherein the gas calorific value of the target node includes a terminal gas calorific value of the terminal node, and the terminal gas calorific value is determined based on the gas usage data, the gas combustion characteristic, and the combustion exhaust gas characteristic;
for each of a plurality of terminal nodes, determining a target gas calorific value of the each of the plurality of terminal nodes, and determining a heat offset value of the each of the plurality of terminal nodes based on the target gas calorific value and the terminal gas calorific value;
determining a valve to be regulated based on heat offset values of the plurality of terminal nodes;
for each of a plurality of valves to be regulated:
determining a calorific value adjustment parameter of a gas supply pipeline corresponding to the each of the plurality of valves to be regulated based on the heat offset values of the plurality of terminal nodes;
determining a calorific value control parameter of the each of the plurality of valves to be regulated based on the calorific value adjustment parameter; and
in response to obtaining an execution confirmation instruction, regulating a valve opening degree of a valve control device according to calorific value control parameters of the plurality of valves to be regulated.
